(19) United States
(12) Patent Application Publication
(10) Pub. No.: US 2011/0175850 A1
(43) Pub. Date: Jul. 21, 2011

(54) INFRARED TOUCH DISPLAY APPARATUS

(75) Inventors: XIN ZHAO, Shenzhen City (CN); ZU-PEI HE, Shenzhen City (CN); XIAO-GUANG LI, Shenzhen City (CN); RUEY-SHYANG YOU, Tu-Cheng (TW); HAN-CHE WANG, Tu-Cheng (TW); KUAN-HONG HSIEH, Tu-Cheng (TW)

(73) Assignees: HONG FU JIN PRECISION INDUSTRY (SHENZHEN) CO., LTD, SHENZHEN CITY (CN); HON HAI PRECISION INDUSTRY CO., LTD., TU-CHEN (TW)

(21) Appl. No.: 12/817,222

(22) Filed: Jun. 17, 2010

(30) Foreign Application Priority Data
Jan. 16, 2010 (CN) 201010300373.2

(51) Int. Cl. G06F 3/042

(52) U.S. Cl. 345/175

(57) ABSTRACT

An infrared touch display apparatus, includes a touch screen, a first circuit board arranged above the screen, a second circuit board arranged at the left side of the screen, a third circuit board arranged below the screen, a fourth circuit board arranged at the right side of the screen, emitters E1˜En and E′1˜E′m evenly spaced and fixed on the first circuit board and the second circuit board, and receivers R1˜Rn and R′1˜R′m evenly spaced and fixed on the third circuit board and the fourth circuit board, to receive the infrared light emitted from the emitters, wherein n and m are natural numbers greater than one. Infrared light emitted by each emitters E1˜En is transmitted along a first direction and a second direction, infrared light emitted by each emitters E′1˜E′m is transmitted along a third direction and the second direction, the first direction is substantially perpendicular to the third direction.

### BACKGROUND

1. Technical Field

The present disclosure relates to touch display apparatuses and, particularly, to an infrared touch display apparatus.

2. Description of Related Art

Referring to FIG. 4, a conventional infrared multipoint touch apparatus is shown. In the apparatus, it is difficult to determine whether a touch point in some touch areas, such as touch areas A, B, C, and D, is touched when two or more touch points are simultaneously touched. For example, when touch points P1, P2, and P3 are simultaneously touched, the apparatus can determine that the touch point P1 is touched by detecting that infrared receivers R01, R′01, and R′03 do not receive infrared light, and determine that the touch point P2 is touched by detecting that infrared receivers R02, R03 and R′02 do not receive infrared light. However, the apparatus cannot determine the touch point P3 is touched just by detecting the infrared receivers R01 and R′02, because infrared light transmitted to the infrared receivers R01 and R′02 is already blocked by the other touch points.

Therefore, what is needed is an infrared touch display apparatus to overcome the shortcomings of the conventional infrared multipoint touch apparatus.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an infrared touch display apparatus according to a first embodiment.

FIG. 2 is a schematic view of an infrared touch display apparatus according to a second embodiment.

FIG. 3 is a schematic view of an infrared touch display apparatus according to a third embodiment.

FIG. 4 is a schematic view of a conventional infrared multipoint touch apparatus.

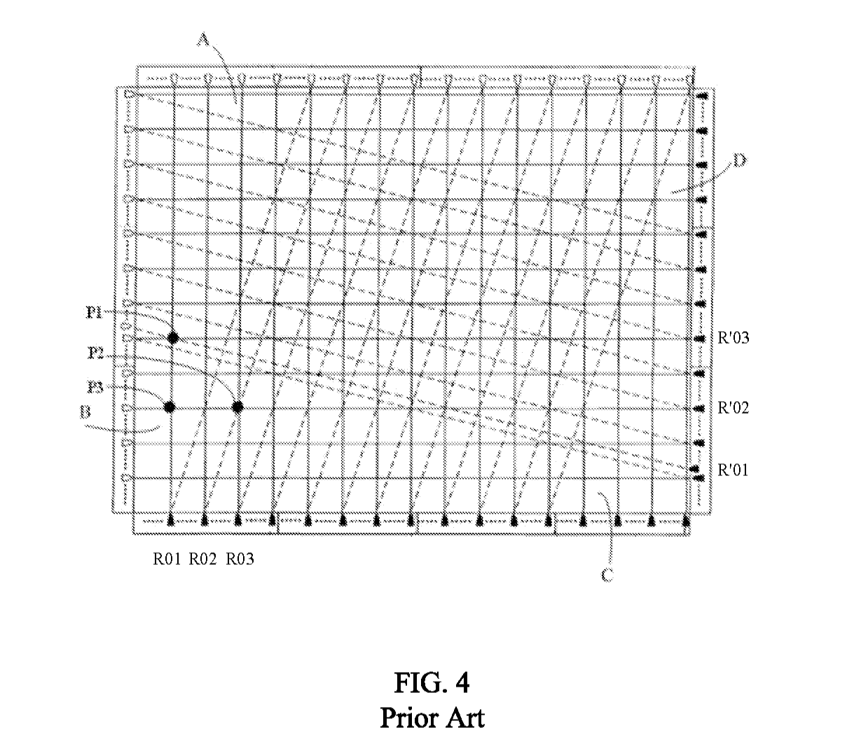

### DETAILED DESCRIPTION

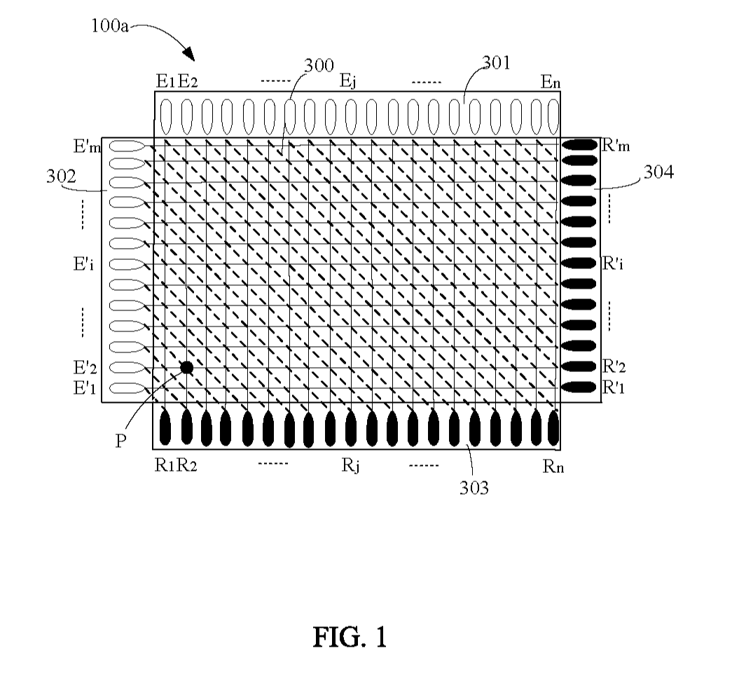

Referring to FIG. 1, an infrared touch display apparatus 100a in a first embodiment is illustrated. The apparatus 100a includes a touch screen 300, four circuit boards 301, 302, 303, and 304 arranged around the touch screen 300, and infrared emitters E1˜En and E′1˜E′m evenly spaced and fixed on the adjacent circuit boards 301 and 302, respectively, and infrared receivers R1˜Rn and R′1˜R′m evenly spaced and fixed on the adjacent circuit boards 303 and 304, respectively. In the first embodiment, n and m are natural numbers greater than one, and n>m. The circuit board 301 is arranged above the touch screen 300, and the circuit board 303 is arranged below the touch screen 300. The circuit board 302 is arranged at the left side of the touch screen 300, and the circuit board 304 is arranged at the right side of the touch screen 300. The emitters E1˜En are evenly spaced and fixed on the circuit board 301 from left to right, and the emitters E′1˜E′m are evenly spaced and fixed on the circuit board 302 from bottom to top. The receivers R1˜Rn are evenly spaced and fixed on the circuit board 303 from left to right, and the receivers R′1˜R′m are evenly spaced and fixed on the circuit board 304 from bottom to top. In the embodiment, the emitter Ej is parallel to the receiver Rj, and the emitter E′i is parallel to the receiver R′i. In the embodiment, 1<=j<=n, and 1<=i<=m.

In the first embodiment, the infrared light emitted by the emitter E′i is transmitted to the receiver R′i in parallel, and is transmitted to the receiver Rj obliquely, and i=j. The infrared light emitted by the emitter Ej is transmitted to the receiver Rj in parallel, and is transmitted to the receiver R(m+j) obliquely, and 1<=j<=n−m. The infrared light emitted by the emitter Ej is transmitted to the receiver Rj in parallel, and is transmitted to the receiver R′i obliquely, and n−m<j<=n, and i=j−(n−m). In other embodiments, it may be that n<m, but the relationship between the emitters and the receivers would be similar to the relationship as described above.

With such configuration, each of touch points P of the touch screen 300 is associated with three infrared emitters and three infrared receivers. That is, the apparatus 100a determines one touch point P is touched when it is determined that the three infrared receivers associated with the touch point P do not receive the infrared light. Therefore, compared to the conventional infrared touch apparatus, in the present touch screen 300, there is no touch point P that cannot be correctly identified.

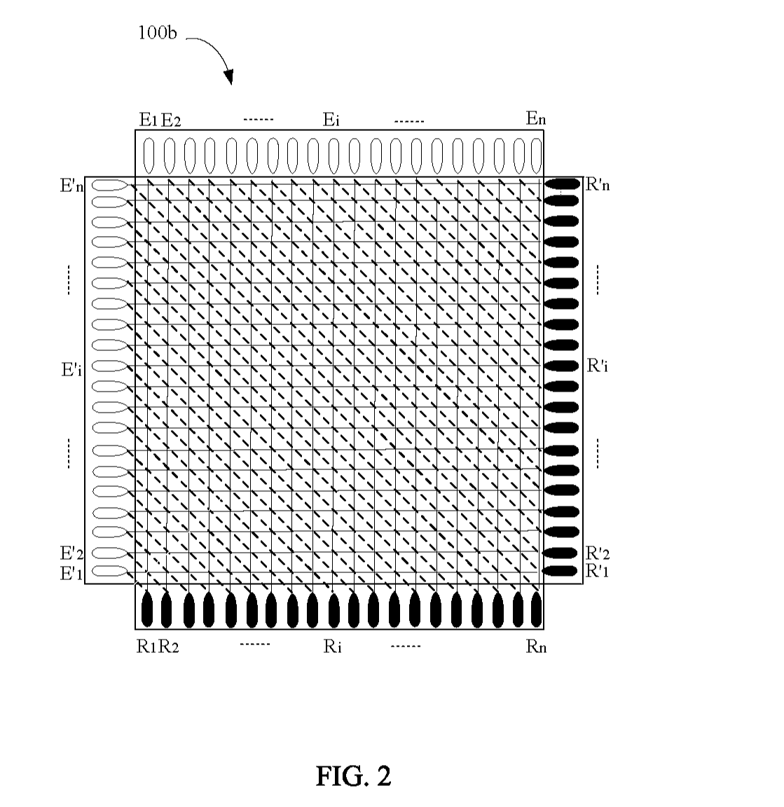

Referring to FIG. 2, an infrared touch display apparatus 100b in a second embodiment is illustrated. Compared to the apparatus 100a, in the apparatus 100b, there are emitters E1˜En and E′1˜E′n and receivers R1˜Rn and R′1˜R′n. The infrared light emitted by the emitter E′i is transmitted to the receiver R′i in parallel, and is transmitted to the receiver Ri obliquely, and the infrared light emitted by the emitter Ei is transmitted to the receiver Ri in parallel, and is transmitted to the receiver R′i obliquely, and 1<=i<=n.

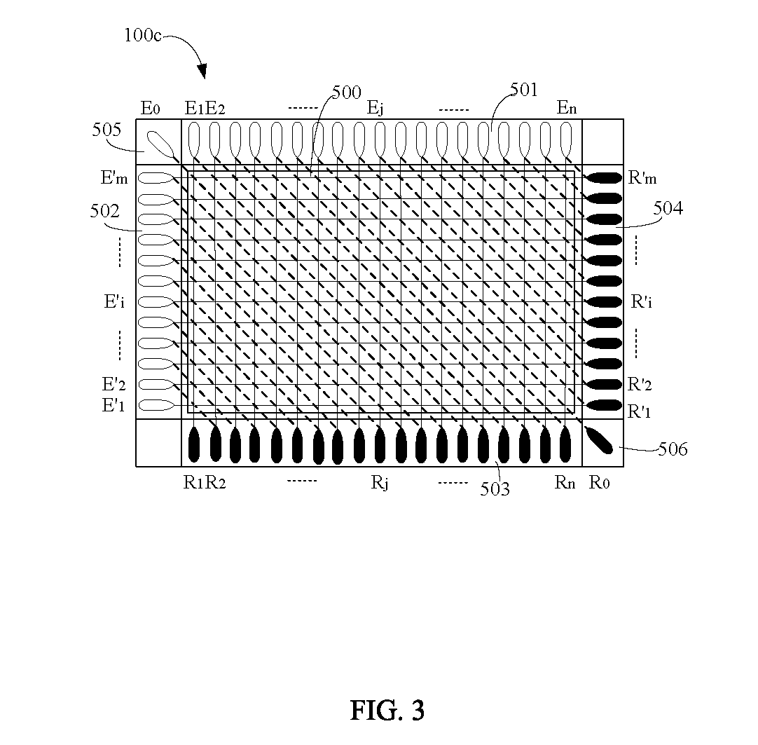

Referring to FIG. 3, an infrared touch display apparatus 100c in a third embodiment is illustrated. Similar to the apparatus 100a, in the apparatus 100c, there are emitters E1˜En and E′1˜E′m and receivers R1˜Rn and R′1˜R′m, and n>m. The difference from the apparatus 100a, is that there is a circuit board 505 arranged between the circuit boards 501 and 502, and a circuit board 506 arranged between the circuit boards 503 and 504. An infrared emitter E0 and an infrared receiver RO are fixed on the circuit boards 505 and 506, respectively.

In the third embodiment, the infrared light emitted by the emitter E′i is transmitted to the receiver R′i in parallel, and is transmitted to the receiver Rj obliquely, and i=j. The infrared light emitted by the emitter E0 is transmitted to the receiver R(m+1) obliquely. The infrared light emitted by the emitter Ej is transmitted to the receiver Rj in parallel, and is transmitted to the receiver R(m+j+1) obliquely, and 1<=j<=n−m−1. The infrared light emitted by the emitter E(n−m) is transmitted to the receiver R0 obliquely. The infrared light emitted by the emitter Ej is transmitted to the receiver Rj in parallel, and is transmitted to the receiver R′i obliquely, and n−m<j<=n, and i=j−(n−m).

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An infrared touch display apparatus comprising:
a touch screen;
a first circuit board arranged above the touch screen;
a second circuit board arranged at the left side of the touch screen;
a third circuit board arranged below the touch screen;
a fourth circuit board arranged at the right side of the touch screen; and
infrared emitters E1˜En and E′1˜E′m evenly spaced and fixed on the first circuit board and the second circuit board, respectively, and infrared receivers R1˜Rn and R′1˜R′m evenly spaced and fixed on the third circuit board and the fourth circuit board, respectively, to receive the infrared light emitted from the infrared emitters, wherein n and m are natural numbers greater than one; the emitter Ej is parallel to the receiver Rj, and the emitter E′i is parallel to the receiver R′i, 1<=j<=n, and 1<=i<=m, infrared light emitted by each infrared emitters E1˜En is transmitted along a first direction and a second direction, infrared light emitted by each infrared emitters E′1˜E′m is transmitted along a third direction and the second direction, the first direction is substantially perpendicular to the third direction.

2. The infrared touch display apparatus as described in claim 1, wherein when n is greater than m, the infrared light emitted by the emitter E′i is transmitted to the receiver R′i in parallel, and is transmitted to the receiver Rj obliquely, and i=j; the infrared light emitted by the emitter Ej is transmitted to the receiver Rj in parallel, and is transmitted to the receiver R(m+j) obliquely, and 1<=j<=n−m; the infrared light emitted by the emitter Ej is transmitted to the receiver Rj in parallel, and is transmitted to the receiver R′i obliquely, and n−m<j<=n, and i=j−(n−m).

3. The infrared touch display apparatus as described in claim 1, wherein when n is equal to m, the infrared light emitted by the emitter E′i is transmitted to the receiver R′i in parallel, and is transmitted to the receiver Ri obliquely, and the infrared light emitted by the emitter Ei is transmitted to the receiver Ri in parallel, and is transmitted to the receiver R′i obliquely, and 1<=i<=n.

4. The infrared touch display apparatus as described in claim 1 further comprising a fifth circuit board arranged between the first circuit board and the second circuit board, and a sixth circuit board arranged between the third circuit board and the fourth circuit board, wherein an infrared emitter E0 is fixed on the fifth circuit board, and an infrared receiver RO is fixed on the sixth circuit board.

5. The infrared touch display apparatus as described in claim 4, wherein when n is greater than m, the infrared light emitted by the emitter E′i is transmitted to the receiver R′i in parallel, and is transmitted to the receiver Rj obliquely, and i=j; the infrared light emitted by the emitter E0 is transmitted to the receiver R(m+1) obliquely; the infrared light emitted by the emitter Ej is transmitted to the receiver Rj in parallel, and is transmitted to the receiver R(m+j+1) obliquely, and 1<=j<=n−m−1; the infrared light emitted by the emitter E(n−m) is transmitted to the receiver RO obliquely; and the infrared light emitted by the emitter Ej is transmitted to the receiver Rj in parallel, and is transmitted to the receiver R′i obliquely, and n−m<j<=n and i=j−(n−m).
